(19) United States
(12) Patent Application Publication
(10) Pub. No.: US 2024/0047664 A1
(43) Pub. Date: Feb. 8, 2024

(54) Optimisation of Mesoporous Battery and Supercapacitor Materials

(71) Applicant: CALIX LTD, Pymble (AU)

(72) Inventors: Mark Sceats, Pymble (AU); Matthew Boot-Handford, Pymble (AU); Dabin Wang, Pymble (AU); Lakshmi Vazhapully, Pymble (AU); Adam Vincent, Pymble (AU)

(21) Appl. No.: 18/550,231

(22) PCT Filed: Mar. 3, 2022
(86) PCT No.: PCT/AU2022/050170

§ 371 Date: Sep. 12, 2023

(30) Foreign Application Priority Data
Mar. 16, 2021 (AU) 2021900754

(51) Int. Cl. H01M 4/505; H01M 4/04; H01G 11/86; H01G 11/46; C01G 45/12

(52) U.S. Cl. CPC H01M 4/505; H01M 4/0471; H01M 4/0402; H01G 11/86; H01G 11/46; C01G 45/1257; H01M 2004/028

(57) ABSTRACT

A process for processing an electroactive mesoporous material into a cathode, or an anode or a supercapacitor material using one or more of the steps of: (a) modifying the material to remove impurities or substitute materials in the powder by a hydrothermal process; (b) intercalating the material by injecting the material with the charge carrier ion using a hydrothermal process or supercritical CO₂ fluid process where the solvent fluid contains a soluble material of the charge carrier ion; (c) sintering the intercalated material; (d) providing a layer of a conducting material within the material pores; (e) filling the pores and interparticle spaces with an electrolyte generally comprising the charge carrier ion and a solvent; and for solid state materials, (f) polymerizing the solvent to encapsulate the powders.

### TECHNICAL FIELD

The present invention generally relates to the production of materials and components for batteries and supercapacitors. This invention is a further application a technology disclosed by Sceats et. al. in WO2018/120590, included herein in its entirety, in which an electroactive micron scale powder may be manufactured using flash calcining of an appropriate precursor material to produce a mesoporous powder which has, when used in a battery or supercapacitor, the desirable electrochemical properties of a nanomaterial, such as fast charge and discharge, without the degradation of performance generally associated with agglomeration of nano-particles. The inventions described herein discloses post production-processes of such mesoporous materials to optimise performance of a battery or supercapacitor produced from such mesoporous powder particles.

### BACKGROUND

The battery industry is undergoing rapid growth to meet a demand growing at over 10% pa, with an expectation of cost reductions of over 10% pa through the uptake of improvements in battery materials and manufacturing processes. The primary costs of battery manufacture are the costs of the anodes and cathode materials, particularly the cathode materials. The disclosures of this invention are related to the improved performance and simplification of manufacturing processes using the mesoporous materials described in Sceats et. al, with a focus on embodiments on cathode materials such a Lithium Manganese Oxide (LMO) spinel, LiMn₂O₄. In this disclosure, a mesoporous materials means a material having a high porosity and a distribution of interconnected pores, called hierarchical, which may span the range from micropores to macropores. LMO in its traditional octahedral spinel crystal structure, shows a reversible de-intercalation plateau at about 4.0 V versus Li/Li⁺. LMO was one of the early battery materials developed, and is the exemplar for the spinel materials where the primary condition for reversible performance is the small volume change associated with deintercalation of lithium during discharge. However, LMO exhibits a significant loss of performance in multiple charge/discharge cycles from a variety of mechanisms which have been well researched. While performance has been increased from these efforts, there is also need for further improvements particularly to meet the demands of new applications, such electric vehicles, where there is a need for both fast charging/discharging and longevity. An aspect of this disclosure is the processing of materials to improve such properties in general for many cathode materials, with particular emphasis on LMO.

Crystalline LMO is an excellent example to consider in the contexts of process and product improvement because it was one of the first lithium ion cathode materials used commercially, and has the intrinsic advantages of using low cost, non-toxic materials. There are extensive studies on the manufacturing issues that need to be improved, and this prior art has established that there are two primary attributes which limit the performance, and a number of other attributes which limit the applications. This disclosure is related to processing methods to overcomes these limitations.

The first aspect to improve performance is to increase the rate of charge/discharge of the battery or supercapacitor material so it can be applied to applications which require this attribute, such as for electric vehicles. One approach is to increase the surface area of the material using nanoparticles. However, these materials tend to agglomerate during cell production, and the structure of these weakly bound materials changed during cycling to minimise the induced electrochemical stresses, so that the initial fast performance quickly deteriorates. Another approach was described by Sceats et. al. in which mesoporous materials could be produced by flash calcination of a larger micron sized powder which has the desirable surface area for a fast response. There are other approaches which have been developed to fabricate stable mesoporous structures for this purpose. This aspect is common to anodes and cathodes of many materials, and specifically applies to LMO.

The second aspect to improve LMO performance is to lower manganese ion dissolution in the electrolyte, which is known to suppress a degradation of performance over many cycles from the loss of manganese of the loaded spinel and the polarisation loss from the increase in the resistance, attributed also to the later deposition of dissolved manganese on the anode. There is a large body of work on this manganese dissolution mechanism which has been reviewed, for example, by Pender et. al. “Electrode Degradation in Lithium-Ion Batteries, ACS Nano, 14, 1243-1295 (2020). The dissolution mechanism is a disproportionation of Mn(III) to Mn(IV) and a soluble Mn(II) phase at the cathode surface, which is accelerated by protons generated from solvent oxidation and salt decomposition/hydrolysis (e.g. LiPF₆ will react with trace amounts of H₂O in the electrolyte to form HF). Further, the discharge curves indicated there is one or more a phase changes in the structure of the LMO material during lithium deintercalation which is sensitive to the temperature, and which are also linked to the dissolution process. The formation of these phases is particularly problematic as its formation leads to a large volumetric expansion of the unit cell and this Jahn-Teller distortion may lead to cracking of the LMO crystals and a breakdown in the ionic and electronic conducting pathways which limits battery performance. One such phase formed by manganese dissolution may be Li₂Mn₂O₄. This cracking also exposes additional electrode-electrolyte interfaces for Mn dissolution to take place and additional solid electrolyte interface (SEI) formation consuming active lithium and further contributing to capacity fade. The formation of Li₂Mn₂O₄ is reported to facilitate Mn dissolution via the irreversible disproportionation at higher voltages>4V forming soluble Mn(II) species (namely Mn₂O₄). It is established that the substitution of Ni, Co, Cr, Ti and Al in the spinel can minimise manganese dissolution. However, the use of the electrochemically inactive ions, Cr, Ti and Al decreases the specific capacity and are undesirable, while the electrochemical additives Ni, Co are toxic, expensive and the amounts that can be added are limited before there is a phase change to the layered structures. There is a wide range of materials that may be made, such as described in U.S. Pat. No. 8,475,959 B2 and production techniques such as spray pyrolysis are described in U.S. Pat. No. 9,446,963 B2, which may encompass the spinel phase materials, as well as other phases.

Another approach to improve performance by suppression of manganese dissolution is to introduce these such substitutes as a thin coating on the surface as hydrogen scavengers close to the particle surface which suppresses the diffusion of H⁺ into the cathode crystal from electrolyte oxidation. Also, the use of more stable electrolytes and a further reduction of moisture may be used to reduce the oxidation.

Another approach to improve performance by suppression of manganese dissolution, relevant to this disclosure, is described in a publication by Li et. al. “Hierarchical porous onion-shaped LiMn₂O₄ as ultrahigh-rate cathode material for lithium ion batteries” Nano Research, 11, 4038-4048 (2018), which reports that a form of LMO, herein called “polyhedral LMO”, may be synthesised by grinding Mn₂O₃ and a stoichiometric amount LiOH·H₂O in ethyl alcohol and calcining at 750° C. for 10 hours. Polyhedral LMO is mesoporous and had a long range structure characterised by polyhedral unit cells, compared to the octahedra of the standard crystalline form of impervious LMO, herein called “octahedral LMO”. Polyhedral LMO has an initial charge storage of about 125 mAh g⁻¹ which is higher than that of octahedral LMO of about 105 mAh g⁻¹ and has faster charging/discharging characteristics typical of mesoporous materials. Importantly, polyhedral LMO showed a lower loss of capacity over multiple cycles, compared to octahedral LMO which was attributed to a lower propensity for manganese dissolution from this structure. The methods of production of polyhedral LMO described in the prior art are not suitable for commercial production.

Generally, there is a need for a commercially applicable means of manufacture of lithiated mesoporous materials to make fast charging powders for anodes and cathodes, and particularly a need for LMO materials which are designed to inhibit manganese dissolution, and specifically a need for a means of manufacturing mesoporous polyhedral LMO suitable for commercial production.

The third aspect relevant to improving cathode performance is to improve the electronic mobility of the cathode material, especially for fast charge/discharge applications. Poor electronic mobility is a characteristic of many cathode materials, including LMO, where the intrinsic electrical conductivity is low in the charged (lithiated), discharged (unlithiated) states, and those states between. This has been conventionally overcome by adding an electron conducting powder, such as carbon, to the electrode formulation. Carbon particles (in conventional electrode formulations) predominantly act as conductive pathway/bridge between the active cathode particles and the current collector substrate. However, for mesoporous materials, the carbon particles cannot penetrate deeply into internal pores of the active electrode material. The particle size of the carbon particles which are greater than the pore widths of the active electrode material cannot penetrate smaller pores. However, very small carbon particles cannot be used to provide electronic conductivity in small pores because when present in the bulk they will penetrate the battery separator and short circuit the battery.

Another approach to improving electrical conductivity is to use carbon coatings. It is noted that carbon coating of LMO electrodes has been disclosed in the review of Li et. al. as a means of providing an electron pathway and inhibiting the manganese dissolution. However, the means of deposition of the coating, by sputtering and the like, is not appropriate to coating the internal pores of mesoporous materials. Carbon-nitrogen coatings have been applied to the production of nanoparticle electrode materials, such as coatings of nanotubes of MnOx anodes by Wang et. al. in “Nitrogen-Enriched Porous Carbon Coating for Manganese Oxide Nanostructures toward High-Performance Lithium-Ion Batteries” ACS Appl. Mater. Interfaces 7, 17, 9185-9194 (2015) and other literature on nano-particle battery materials. This approach for nanoparticles has limited use for coating mesoporous materials. There is a need for a process that can be used for deposition of conducting carbon, and enriched carbon coatings in the mesopores of battery materials generally to increase electrical conductivity, and for porous manganese-containing electrode materials to inhibit manganese dissolution, and specifically for mesoporous LMO batteries for improved conductivity and manganese dissolution inhibition.

A fourth aspect for improved cathode production is a process that is appropriate for solid state batteries, using solid state electrolytes. The electrolytes may be for enhanced electronic of ion conduction, or both. Solid state batteries have an intrinsic benefit of safety because the propensity of fire at high temperature, generally from the use of liquid electrolytes, is known to be significantly reduced in a solid state battery structures. The prior art for solid state electronic conductors, such as polyaniline (PANT) materials as has been reviewed by Bhadra et. al, in “A review of advances in the preparation and application of polyaniline based thermoset blends and composites” Journal of Polymer Research 27, 122 (2020). The polymerization of such materials may be initiated by light. The prior art for manufacture of solid state batteries ionic conductors has been such as reviewed by Yang et al in “Advances in Materials Design for All-Solid-state Batteries: From Bulk to Thin Films”, Appl. Sci., 10, 4727-4777 (2020) and Wang et. al. in “Fundamentals of Electrolytes for Solid-State Batteries: Challenges and Perspectives” Front. Mater., 16 Jul. (2020). There is a general problem with polymer materials for solid state batteries in which a material which is flexible enough to limit the build-up of electromechanical stresses do not have enough strength to maintain the structure. The materials with desirable properties include polystyrene-polyethylene oxide block copolymers, nanoscale-phase separation of polymer materials with a combination of desirable properties of ion conductivity and strength, crosslinking with hairy nanoparticles and the addition of lithium loaded nano-ceramic particles.

The loss of efficiency through cycling is determined by the same mechanisms described above for liquid electrolytes. Indeed and the loss of performance of solid state batteries is generally more severe than with liquid electrolytes because the development of stresses within the particles cannot be relaxed by a flow mechanism available to liquid electrolytes. Hence the stresses accumulate and the materials are prone to shattering with loss of performance. This degradation offsets the potential advantages of using solid metal films for the anode in a battery. There is a need to develop solid state electronic and ionic conductors in which the development of stresses during charge and discharge is significantly reduced for both batteries and supercapacitors.

A fifth aspect of cathode production is the potential to use low cost materials that can be purified as part of the production process. There is a growing need to reduce production costs of battery materials. For example, materials for the battery production are manufactured as hydroxides or carbonates by standard precipitation processes, yet such processes have limitations for impurity separation, particularly for heavy metals. There is a need for processes in the production process that can facilitate improved impurity reduction.

Another aspect for performance improvement is the application of the processing steps described above to the production of supercapacitors. It would be appreciated by a person skilled in the art that there is a link between fast charging batteries and supercapacitors. In supercapacitors, the focus is on maintaining the surface area of the contact between the powder and the electrolyte whereas a battery has a higher demand on a wider range of processes. An example is the use of MnO₂ as described by Wu et. al in “MnO₂/Carbon Composites for Supercapacitor: Synthesis and Electrochemical Performance”, Front. Mater., February (2020), in which MnO₂ nanoparticles are coated by carbon composites so that the high electrical conductivity of the carbon fibres is offset by the high charge density of MnO₂. The means of production of such composite carbon-inorganic materials is complex in order to limit the collapse of the structure, and the degradation of performance, from the intense electric fields required by supercapacitors.

Another aspect relevant to this disclosure is a means of separating lithium from minerals such as spodumene and in this respect, the prior art of Sceats, Vincent et. al in AU2020902858 “A method for the pyroprocessing of powders”, included herein in its entirety, in particular using flash calcination of crystalline a spodumene to mesoporous β,γ spodumene, which is relevant to the disclosure of this patent, in this regard. The purification of the materials begins at the mine site. The potential to use high pressure CO₂ to extract lithium from aluminosilicates has been disclosed by Correia in U.S. Pat. No. 9,028,789 “Process to produce lithium carbonate from the aluminosilicate material”, which was directed to extraction of a spodumene without calcination, and the process was shown to be very slow, over more than six hours. There is a need to accelerate the speed of the extraction process.

More generally, mesoporous materials may be used to produce either batteries or supercapacitors using the process steps disclosed herein. In that context, processes and materials described herein for applications in a battery or a supercapacitor may generally apply to the other application.

Any discussion of the prior art throughout the specification should in no way be considered as an admission that such prior art is widely known or forms part of common general knowledge in the field.

### SUMMARY

### Problems to be Solved

It may be advantageous to produce precursors for the manufacture of battery and supercapacitor materials in a process in which impurities which degrade performance of the battery are removed when the mesoporous material is processed, or materials are added to improve performance using hydrometallurgical (“the hydrometallurgical process”) and/or thermal processes (“the pyroprocess”).

It may be advantageous to use mesoporous powder materials for making or recycling batteries and supercapacitors where processing to improve performance uses supercritical CO₂ drawn into the mesoporous materials (“the supercritical CO₂ process”).

It may be advantageous to provide for processes to manufacture stable mesoporous intercalated powder materials for use in rechargeable battery cells and supercapacitors (“the intercalation process”).

It may be advantageous to provide for a process to produce stable mesoporous materials with a fast response by application of carbon films to enhance electron conductivity so that the battery or supercapacitor can deliver a high power response (“the coating process”).

It may be advantageous to provide for a process to produce stable mesoporous materials for solid state materials with a fast response by polymerization of electrolyte materials within the mesoporous materials that can enhance ionic conductivity so that the battery or supercapacitor can deliver a high power response without deleterious safety issues of conventional liquid and liquid/solid electrolytes (“the polymerization process”).

It may be advantageous to provide for an overall process to produce materials in which the processes of hydrometallurgy, pyroprocessing, the supercritical CO₂ process, intercalation, coating and polymerization described herein are carried out in sequences or combinations or repetitions that optimise the performance and costs of a particular battery or supercapacitor material.

### Means for Solving the Problem

A first aspect of the present invention may relate to a process for processing an electroactive mesoporous material into a cathode, or an anode or a supercapacitor material using the steps of: (a) modifying the material to remove impurities or substituting materials in the material by a hydrothermal process; (b) intercalating the modified material by injecting the modified material with a charge carrier ion using the hydrothermal process or supercritical CO₂ fluid process where a solvent fluid contains a soluble compound of the charge carrier ion; (c) sintering the intercalated material; (d) providing a layer of a conducting material within the sintered material pores; (e) filling the pores and interparticle spaces with an electrolyte comprising the charge carrier ion and the solvent; and for solid state materials, (f) polymerizing the solvent to encapsulate the mesoporous material.

Where a common feature of the process steps involving fluid materials is that the capillary action of the pores in the mesoporous material pulls the fluid into the pores, and the fluid is chosen to substantially wet the pores of the material; and each process is carried out to ensure that the mesopore structure of the solid material is preserved; and wherein lithiation by hydrothermal processing the mesoporous powder in a 1-5M solution of LiOH followed by sintering produces a spinel lithium manganese oxide Li₁₊ₓMn₂₋ₓO₄ (LMO); and wherein the lithium ratio is controlled to give the stoichiometric ratio of Li:Mn=1, to produce a tetragonal mesoporous material Li₂Mn₂O₃ (OLO) for use as a source of excess lithium in a cathode battery formulation.

Preferably, the electroactive material is produced by either flash calcination of a precursor material that creates porosity by volatilisation of constituents or by synthesis of a material, where the particle distribution is typically that of powders in the range of 1-100 microns and the preferable pore properties are: (a) a porosity in the range of 0.4-0.6; and (b) a pore distribution with pores preferably in the range of 3-130 nm; and (c) a continuous pore structure which is hierarchical without a signification fraction of closed pores; and (d) a Youngs modulus of preferably less than 10% of that of the solid material.

Preferably, the electroactive material may be mesoporous. Preferably, the modification step (a) wherein the impurity extraction rate, or substitution rate, maintains the grain size of the material as low as practicable, and preferably less than about 40 nm; and which enables the production of stable mesoporous forms of the material.

Preferably, the intercalation step (b) and the sintering step (c) is be operated over the course of multiple steps to achieve the desired stoichiometric transformation of the lithiated material to the desired composition, and the thermal stage, is optimised to achieve the desired stability of the material, while minimising mesopore ripening and/or facilitating desirable forms of the material for use as an anode, a cathode or a supercapacitor.

Preferably, the electron conducting step (d) uses organic compounds such as sucrose, polystyrene, acetic acid, oxalic acid and citric acid dissolved in water, which after hydrothermal synthesis and/or pyrolysis, a conducting film of carbon is formed or preferably adhered to the pore surfaces.

Preferably, the electron conducting step (d) uses small grains of polyaniline in a solvent to form electron conducting pathways through the mesopores when the solvent is removed.

Preferably, the electrolyte used in step (e) is Li⁺PF₆⁻ dissolved in a mixture of cyclic and linear organic carbonates such as ethylene carbonate, dimethyl carbonate, ethyl methyl carbonate and diethyl carbonate.

Preferably, the polymerized electrolyte of step (f) has a high lithium conductivity, including materials such as polystyrene-polyethylene oxide block copolymers, nanoscale-phase separated materials, crosslinked materials with hairy nanoparticles, and lithium loaded nano-ceramic particles.

Preferably, the mesoporous material is a manganese oxide produced using a manganese salt with volatile constituents, such as manganese salts in which the manganese salts is one or more selected from the group of: managanese carbonate, manganese acetate, and manganese citrate; in which, when flash calcined in a controlled atmosphere liberates CO₂ and H₂O as appropriate, to give a calcined material, where the calcination conditions are selected to produce the mesoporous material, and specifically a material with a specific surface area exceeding 20 m²/g and a composition which is a mixture of Mn₃O₄, MnO, Mn₂O₃ and uncalcined materials, with the Mn₃O₄ form dominating.

Preferably, the use of the mesoporous powder and the lithiation step by hydrothermal processing the powder in a 1-5M solution of LiOH and sintering steps to produce a spinel lithium manganese oxide Li₁₋ₓMn₂₋ₓO₄ (LMO), wherein the adsorption of lithium was controlled for the spinel lithium manganese oxide Li₁₋ₓ Mn₂₋ₓO₄ (LMO) where x=0-0.1, and the conditions included capillary action to draw the liquid into the mesoporous powder, heating the slurry and shearing the slurry to promote uniform lithiation, and the processing conditions, including additives such as surfacants, selected to produce an LMO powder with the highest specific surface area and the crystalline form of the powder was the mesoporous polyhedral material for use as a cathode material for batteries.

Preferably, the lithium ratio is controlled to give the stoichiometric ratio of Li:Mn=1, to produce the tetragonal mesoporous material Li₂Mn₂O₃ (OLO) for use as a source of excess lithium in a cathode battery formulation wherein a portion of about 5% of the tetragonal mesoporous material Li₂Mn₂O₃ (OLO) is mixed with the LMO.

Preferably, the mesoporous material in which a manganese material oxide produced using a manganese salt with volatile constituents, such as manganese carbonate, which, when flash calcined in a controlled atmosphere liberates CO₂ to give a calcined material, where the calcination conditions are selected to produce a mesoporous material having the properties described above, as well as to manufacture a product which had the highest specific surface area that can be obtained by varying the calcination conditions, preferably to exceed of 60 m²/g and the preferred product is a mixture of MnO₂, Mn₃O₄, Mn₂O₃ and uncalcined precursors forms, with the MnO₂ form desirably dominating by use of a postprocessing oxidation step.

Preferably, the mesoporous material which is processed using the technique of the modification step (a) wherein the impurity extraction rate, or substitution rate, maintains the grain size of the material as low as practicable, and preferably less than about 40 nm and (b) which enables the production of different forms of the material in terms of the crystalline or amorphous phase including phases that rely on mesoporosity to facilitate forms with desirable long range order; and another processing step in which that the fraction of MnO₂ is increased in the mesoporous product material.

Preferably, the mesoporous material which is processed using the processes of the electron conducting step (d) using organic compounds or using small grains of polyaniline in a solvent to provide a conducting carbon film on the surface of the pores, so that the material, when loaded with an electrolyte composed of specified ions such as lithium or lithium ions, the material is used in the production of a supercapacitor.

In another aspect or preferably, the mesoporous material β,γ spodumene produced by flash calcination of a spodumene which is mixed in a pressurised heated mixture supercritical CO₂ and water, so that the lithium in the mesoporous β,γ spodumene is extracted within a time of 2 hours in the form of dissolved lithium carbonate. Preferably, the mixture of CO₂, steam and lithium carbonate, when separated from the solid residual aluminosilicate and the pressure is reduced to form precipitates of lithium carbonate. The mesoporous material β,γ spodumene produced by flash calcination of a spodumene which is mixed in a pressurised heated mixture supercritical CO₂ and water, so that the lithium in the mesoporous β,γ spodumene is extracted within a time of 2 hours in the form of dissolved lithium carbonate. Preferably, the mixture of CO₂, steam and lithium carbonate, when separated from the solid residual aluminosilicate, and the pressure reduced, precipitates crystals of lithium carbonate which may be used in the production of lithium ion batteries, and the CO₂ gas and steam stream is compressed to form supercritical CO₂ and water streams which are recycled for use in the step of flash calcination of a spodumene.

The means of solving the problem may start with the prior art disclosed in the invention described by Sceats et. al. in which a micron sized powder, the precursor material, is flash calcined to produce a mesoporous material, usually an oxide, in which the grains of the product material are dominantly on the nano-meter scale, about 3-100 nm, and the porosity of the material is in the range of 0.4-0.6 and a high surface area, preferably greater than about 20 m²/g. Another feature of such a material is that it has a very low Youngs modulus, which means that the powder can deform under stresses without fracturing. A further feature is that the oxidation state can be controlled during production by adding gases with different redox potentials at the calcination conditions, or processing the hot calcined material in a second reaction stage. Such a material is defined herein to be mesoporous.

The precursor material for flash calcination is selected so that the mesoporous powder product has desirable electroactive properties so that it may be used for fabricating batteries and supercapacitors.

While nanoparticle agglomerates of electroactive materials for batteries and supercapacitors have been found to be susceptible to electrochemical stresses that result in fast degradation, the inventions disclosed herein may also be applied to strong composites of nanomaterials which have properties that emulate the mesoporous properties produced by the flash calcination process described by Sceats et. al. For example, the disclosures of this invention may apply to composites formed by sintering nanoparticle agglomerates, or setting nanoparticles in a stable polymer matrix so that the structure is not subject to significant irreversible structural change during multiple charge/discharge cycles. The common property is that a material used for the application of the process steps disclosed herein is mesoporous.

This invention deals with the postprocessing of such mesoporous materials, with respect to hydrometallurgical and pyroprocessing, supercritical CO₂ processing. intercalation, coating and polymerization can occur inside the material to enhance the performance of the materials for batteries and catalysts. A common feature of these processes is the drawing of a fluid state into the mesoporous material by capillary forces, where the fluid composition is designed to carry out one or more of these processes. The range of fluids includes water and supercritical CO₂.

With respect to hydrothermal processing, the means of solving the problem is choose a solvent, say water, with, for example, a particular pH set additives such as buffers and chelates, which is designed to dissolve the impurities or to replace materials to enhance performance. This is the general area of hydrometallurgy. Many of the impurities are traditionally removed during preparation of the precursor material by crystallisation. In this disclosure, residual impurities may be extracted from an interface by such processes, or materials may be deposited. The thermodynamics and chemical kinetics may be sufficiently different from bulk hydrothermal processes that there is scope for improvement of the material and the processing costs. Most importantly, it is the impurities at the grain surfaces that are most important in failure mechanisms, and in a mesoporous material, the grain interfaces are exposed by pores that can carry liquids. The washing of the mesoporous material the internal pores may be a first beneficiating process. This and other hydrothermal processes may be required for any of the subsequent steps described below.

With respect to the process of intercalation, the intercalation, or loading, of mesoporous materials by the conducting ion is traditionally done my mixing the powder material with a powdered salt of the conducting ion, and roasting at high temperatures or spray drying. For example, lithium is intercalated into oxides materials by mixing lithium carbonate LiCO₃, or lithium hydroxide LiOH or hydrated lithium hydroxide LiOH·H₂O or mixture of these with the oxide and roasting in air, nitrogen, CO₂, argon or a redox gas. For manganese materials the oxide may be MnO₂, Mn₃O₄, or Mn₂O₃ as required. For LMO batteries, the preferable material is dominated by Mn₃O₄. These are examples of a standard process generally applied to powders, and the rate of intercalation depends on the surface diffusion rate of the ion, in this example, Li⁺ to move into the particle. When used with standard powders, the process can be enhanced by processes such as ball milling which force the exchange of materials. The alternative process disclosed herein it to dissolve the lithium materials into a solvent, such as buffered water or supercritical CO₂, and use the capillary forces to suck the fluid into the mesopores to reduce the length scale over which thermal diffusion has to take place. For example, for a highly mesoporous material with a grain size of 15 nm, the diffusion length is reduced from 15 μm for a typical impervious particle, to the grain dimension to 15 nm of a mesoporous material. Fluid capillary injection is a simple process, but may suffer because a single process may not supply a sufficient material to produce a stoichiometric amount of material to make, say, LMO. However, it is known that cathode materials, such as manganese oxides may self-lithiate in such solutions, because LMO is a more stable compound under such conditions. Thus the lithiation process is controlled by kinetics without the need to mix materials to obtain a stoichiometric mixture. By control of pH and redox potential, temperature and pressure, self-lithiation may be achieved from a saturated solution. Alternatively, the process may be completed by a number of processing steps in which the delithiated solution is sucked out, and replaced to provide more lithium ions, and/or the temperature or pressure is increased to stimulate lithiation in solution, and/or the material may be dried and roasted, where such thermal process may include using spray driers, muffle furnaces, conveyors, microwave heaters, or flash calciners; and the various process steps may be repeated to optimise the extent of lithiation. It will be shown below, in a particular embodiment for polyhedral LMO that the formation of the preferred polyhedral crystal habitat may also be controlled by such conditions, including the mesoporosity. Thus, the long range order of the polyhedral form may be determined by the “free” volume on the scale of many nanometers that is available for mesoporous materials. The volume change from intercalation of lithium is very small, so that the mesoporosity is largely unchanged by intercalation. The mostly likely sequence is that washing of the intercalated material may subsequently take place to remove any additives used to promote intercalation and excess materials. For sodium and magnesium batteries, the diffusion length is small and slow, and the same process steps may be used for intercalation processes.

It is known that lithium batteries may run with excess cathode or anode materials to overcome the loss of lithium from SEI layers and the like. While this may be managed by preparing materials with excess cathode or less anode materials, the loss of performance is a feature that should be minimised for a particular pair of batterers.

In another embodiment, the material Li₂MnO₃, known as a member of a class of Over-Lithiated Oxide (OLO) materials. Li₂MnO₃ may be formed as a mesoporous material using excess lithium in the intercalation of Mn₃O₄. The loss of lithium during charge and discharge cycles may be overcome by using either a mix of these materials or over-lithiating the Mn₃O₄ material to form and mix of LMO and OLO. The advantage of using OLO as a source of lithium is that the loss of lithium from OLO generates LMO.

With respect to the process of conducting carbon coatings, the traditional processes of coating exposed surfaces of micron sized particles is ineffective for mesoporous systems, and the coating individual nanoparticles is not relevant. The preferred method disclosed for internal coating is to inject a solution of a soluble organic material, such as sucrose in water for carbon, or polycyclic organics for other materials for a carbon/nitrogen balance into the mesoporous material, followed by the steps of drying and then partial pyrolysis of the material to generate a carbon or carbon/nitrogen film on the pore surfaces which provides the desired electron conducting pathway on the grain surfaces within the mesopores, and in the case of manganese materials, further inhibit dissolution. The pyrolysis step may be controlled by the temperature and time of the heating process, and the composition of the gas. The evidence from tests is that the carbon based coatings adhere strongly to cathode materials.

The thickness of the coating depends on a trade-off between factors appropriate for the application. In general terms, the ionic and electron diffusion times which that should ideally be short, and equal for many applications. The rate limiting steps are determined from measurement of charge/discharge performance. The thickness of the conducting coating is one such contribution. The composition of the coating can contain other elements such a sulphur and phosphorous. EPR and NMR techniques may be used to optimise the variables.

With respect to general processing with liquid electrolytes, the process is to use capillary action to draw electrolyte into the particle, with or without conduction particles. This is a natural process that integrates well with standard battery production process, and is a known art. It is the use of mesoporous materials to enhance the capillary action, including the conditioning of the pore surfaces for the particular processes.

With respect to polymerization, the method disclosed is to use capillary action to fill the space with a material that later polymerizes within the mesoporous material, where the polymer is selected to provide an electrical, ionic conduction or combined paths. It was noted earlier that am important property of mesoporous materials is their low Youngs modulus, and the polymer can be chosen so that the volume changes from the polymerization process has little propensity to fracture the particle. The low Youngs modulus is a property of the small size of the intergrain contacts. It is therefore preferable that the other post processing steps disclosed herein do not significantly reduce this property, insofar as the fracturing of solid battery and supercapacitor materials is the largest factor which has limited the development of solid state batteries.

In the context of the present invention, the words “comprise”, “comprising” and the like are to be construed in their inclusive, as opposed to their exclusive, sense, that is in the sense of “including, but not limited to”.

“Lithiate” is defined as to combine or impregnate with lithium or a lithium compound. A lithiated powder or material has been combined or impregnated with a lithium or a lithium compound.

The invention is to be interpreted with reference to at least one of the technical problems described or affiliated with the background art. The present invention aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1A illustrates an image of a powder precursor material manganese carbonate MnCO₃ which has been produced by flash calcination of the precursor material.

FIG. 1B illustrates an image of a powder precursor material the mesoporous manganese oxide Mn₃O₄ powder which has been produced by flash calcination of the precursor material.

FIG. 2 illustrates an embodiment of a process flow in which a mesoporous powdered material is processed into an intercalated solid state battery material.

FIG. 3A illustrates an image of LMO particle (Material X) from the process showing the polyhedral structure; FIG. 3B illustrates an image of Commerical LMO Material Z showing the octahedral structure of the small crystal grains. These figures illustrate an embodiment of a mesoporous cathode material showing an image of polyhedral lithium manganese oxide which has been produced from mesoporous manganese oxide by the processes of hydrothermal processing to remove impurities, intercalated by lithium by processing the powder in an aqueous solution of lithium hydroxide, then dried and thermally processed compared to a commercial material.

FIG. 4 illustrates an embodiment of a battery by showing the evolution of the charge capacity as of a cathode half-cell of polyhedral lithium manganese oxide through a number of charge/discharge cycles in at different charge/discharge rates, compared with the evolution of a cathode half-cell of standard octahedral lithium manganese oxide fabricated using the same processes.

FIG. 5 illustrates an embodiment of battery performance by showing the evolution of the cathode charge capacity of a battery of polyhedral lithium manganese oxide as the cathode and LTO as the anode, with excess anode, compared with the evolution of a cathode charge capacity in which a standard octahedral lithium manganese oxide is used as the cathode, where the cells were fabricated using the same processes. Full cell cycle life tests comparing the specific capacity of a battery of polyhedral lithium manganese oxide (Polyhedral versus Octahedral LMO) as the cathode and lithium titanium oxide as the anode, with excess anode.

FIG. 6 illustrates an embodiment for extraction of lithium from the mineral spodumene which shows a process flow in which lithium carbonate is extracted from flash calcined mesoporous β,γ spodumene produced by flash calcination of a spodumene using supercritical CO₂.

### DESCRIPTION

Preferred embodiments of the invention will now be described with reference to the accompanying drawings and to non-limiting examples.

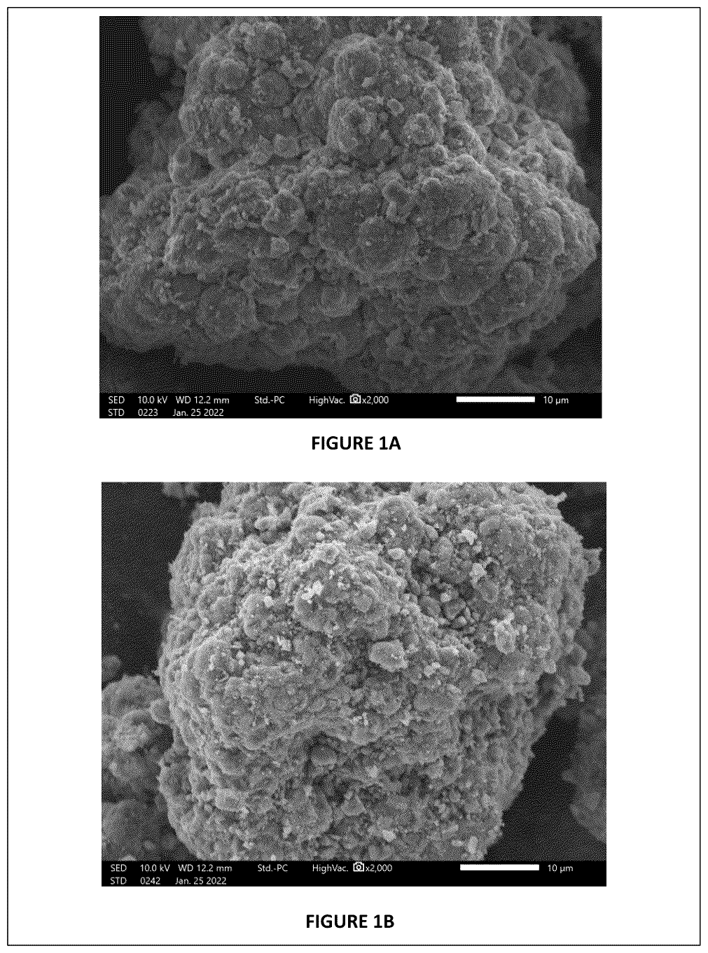

The present disclosure is directed towards a process flow in which a mesoporous powder material is used to manufacture battery materials. The embodiments described herein generally uses an example of a mesoporous manganese oxide prepared from flash calcining manganese carbonate using the process described by Sceats et. al. FIG. 1 illustrates the desired properties of a mesoporous material using Mn₃O₄ as an example. Manganese carbonate, MnCO₃, a precursor material shows typical, impervious, crystals derived from a crystallisation step in a hydrothermal processing step from extraction of manganese from minerals, principally for use in steel production.

TABLE 1
Manganese Carbonate precursor composition

| | Relative Molar Fraction* |
|---|---|
| Mn | 92.9 |
| Si | 4 |
| Fe | 1 |
| Al | 2 |
| Pb | 0.1 |
| | 100 |

*Excludes volatiles and oxygen

Such a precursor material, and its calcined product, has a typical manganese composition shown in Table 1. This is relevant because the levels of such impurities would not normally qualify these materials for use in current battery manufacturing processes. The disclosures of this invention demonstrate that high performance batteries may be made from such a material using process steps disclosed herein. It is noted that many battery materials are optimised by adding other materials into formulations to optimise performance, eg to suppress manganese ion disproportionation in the cathode material, so that bulk impurities may not have a dominant impact per se.

The preferable particle sizes cover the range of 1-150 μm, and it is preferable that the distribution is broad so that packing of the particles in a battery of supercapacitor, with electrolytes and other additives, gives a preferably dense material.

FIG. 1B shows the image of the material which is produced by flash calcination in air, which is identified from its X-ray diffraction profile as Mn₂O₃·MnO, described as Mn₃O₄, as a spinel material which is desirable for intercalation by lithium for battery applications. The particles of the Mn₃O₄ product are about the same size as the MnCO₃ particles, so that the loss of the CO₂ and the partial oxidation of Mn(II) to Mn(III) is such that particle size is not significantly diminished. Thus the porosity of the material is very high, and is readily estimated from material densities as about 0.5. For later reference, the net porosity of the mesoporous LMO can be estimated from its material density as about 0.4. These two porosities are sufficiently low that that the post processing steps described in the following embodiments by liquid capillary action can be carried out. The pore distribution properties of the materials has been measured to show that there is a wide distribution of pores in the range of 10 nm to about 130 nm, which are mesopores, and that they are hierarchically disposed to form a permeable network. This originates from the method of manufacture by flash calcination by which the pores evolve to allow the volatile gases to escape the particle, and these pores may facilitate the diffusion of liquids to enable the processes disclosed in this invention to proceed. The movement of liquids through this porous network is assisted by the capillary suction of mesopores, and in the case of aqueous solutions and related liquids, this is promoted by the wettable nature of oxide surfaces. Another feature of these mesoporous materials is that their Youngs modulus is much lower than the bulk crystals because the high porosity and the small grain size is such that the grains are bonded by thin necks, which enables flexibility during the process steps and the charge/discharge steps. The Youngs modulus of the mesoporous Mn₃O₄ of 7% of the bulk and LMO is about 15% of the bulk. In the case of manganese materials, this benefit may be diminished because of the disproportionation reactions of the Mn(II) ions in the structure at the grain surfaces driven by the breakdown rection products of electrolytes, and suppression of this is desirable.

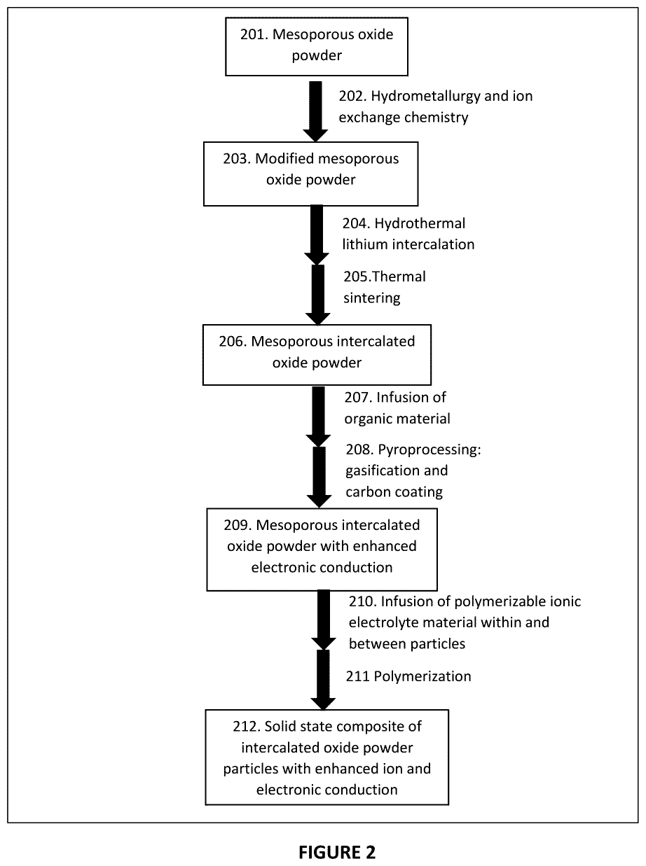

FIG. 2 shows an example embodiment of the process steps enabled by the mesoporous nature of the material produced by flash calcination. in the first step 201 a mesoporous oxide powder 202, such as Mn₃O₄ shown in FIG. 1B, is first optimised by a hydrothermal process which is designed to remove impurities such as those shown in Table 1 and/or to introduce new ions into the mesoporous materials, in one of more steps, to ultimately improve the battery performance. In the case of manganese materials, the approach if to modify the surface to minimise the surface degradation processes from electrolyte decomposition, where the electrolyte is introduced in a subsequent step. An example is the hydrolysis of the electrolyte Li⁺PF₆⁻ which reacts with the solvent at battery operating temperatures to release oxidising species that degrade the surface of the LMO grains. This can be reduced by cleaning the Mn₃O₄ and substitution of ions on the surface that resist the oxidation step. The known art of hydrometallurgy and ion exchange chemistry enables the additives and activators for this process, and application of techniques to permeate a liquid particles for this process. The material 203 is described as a modified mesoporous metal oxide. The first stage of the second step 204 is hydrothermal intercalation of the conducting ion, in which an aqueous solution of a salt containing the conducting ion, such as LiOH is infused into the modified mesoporous oxide particles where the conduction ion is incorporated into the particle as a chemical process to absorb lithium ions, and the second stage 205 is to dry and thermally sinter the intercalated material to form a stable crystalline grained structure. The product is a mesoporous intercalated metal oxide powder 206. The driving force for the conducting ion to intercalate is the lower free energy of the intercalated material. The third step is to form a conducting carbon film on the pore surfaces of the mesoporous powder through a process in which the first stage 207 is the infusion of a solution of an organic material, such as sugar, and the second stage 208 is the pyroprocessing step of gasification of volatiles and the formation of a carbon film adhered to the intercalated grain surface to make a thin carbon film for electron transport, through which the conduction ion can migrate to reach the electrolyte in the pores when incorporated into a battery. The product 209 is a mesoporous intercalated oxide powder with enhanced electronic conduction within the coating and a fast ion conduction through the coating. The fourth step is to form a solid state material in which the pores of the mesoporous material 209 are filled in a first step 210 in which a polymerizable liquid is infused into the particle pores, and between the powder particles which is then set in the second step 211 by inducing the polymerization by the application of light or heat where the polymer material has the desirable attributes of fast ionic conduction. In this embodiment the desirable polymerizable material may contain nanoparticles of materials with a high ionic conductivity. The material produced 212 is a of a solid state electrode of the powder and polymer which has the desirable attributes of fast reversible electron and ion mobilities and energy storage.

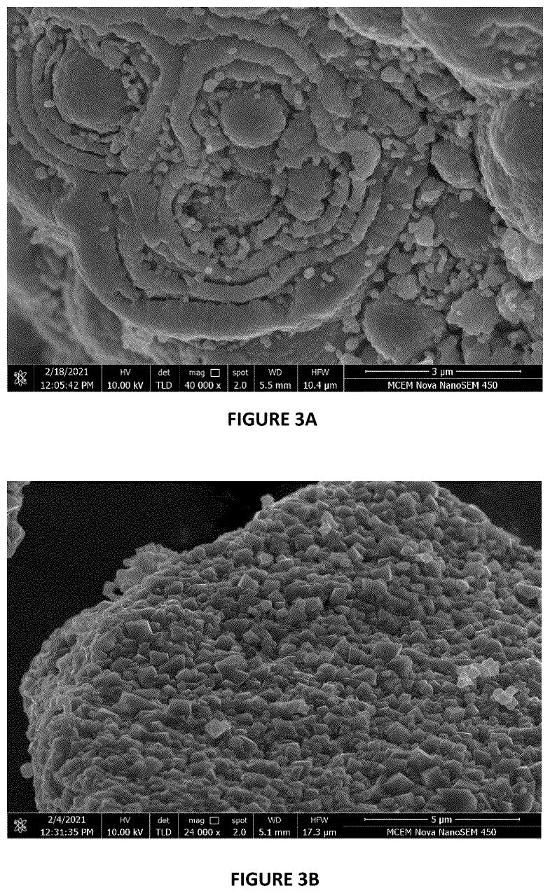

FIG. 3A of mesoporous LMO material, denoted as Material X, showing an image of polyhedral lithium manganese oxide which has been produced from mesoporous manganese oxide by the processes of hydrothermal processing to remove impurities, intercalated by lithium by processing the powder in an aqueous solution of lithium hydroxide, then dried and sintered, which shows the same structure as reported by Li et. al; and FIG. 3B from a dense commercial polycrystalline material, denoted as Material Z which shows the octagonal structure.

An embodiment of the LMO in a half cell battery produced by the processes disclosed herein as the curve 401 which shows the evolution of the charge capacity of a cathode half-cell X through a number of charge/discharge cycles, compared with the evolution 402 and 403 of several commercial LMO materials Y, Z fabricated using the same processes and subject to the same charging/discharging conditions. The commercial sample Y is a typical LMO from the manufacturers specifications, whereas the sample Z is a best-of-class LMO based on its specifications. The higher charge density of the X compared Y and Z shows better performance of the LMO with the produced by the inventions described herein, and established the superior properties which may be associated with the suppression of manganese dissolution by polyhedral LMO.

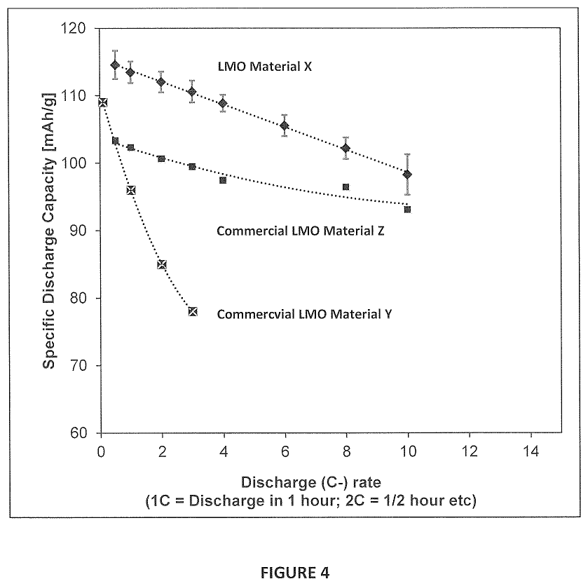

FIG. 4 illustrates an embodiment of a battery by showing the evolution of the charge capacity as of the cathode half-cell X of polyhedral LMO as a function of the charge/discharge rate C, compared with the evolution of a cathode half-cell of commercial lithium manganese oxide Y and Z fabricated using the same processes. The charge rate C is the reciprocal of the time in hours used to charge or discharge the cell. The ability of X to operate at higher rates than Y and Z may be associated with the mesoporous open structure of the polyhedral LMO.

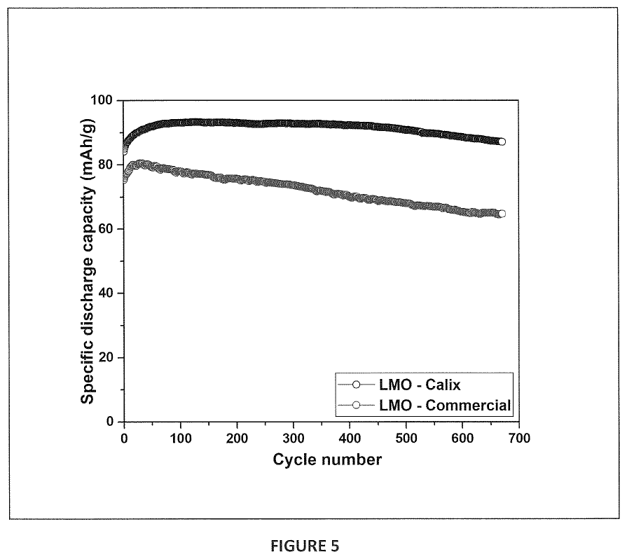

FIG. 5 illustrates an embodiment of battery performance by showing the evolution of the cathode charge capacity of a battery of polyhedral lithium manganese oxide X as the cathode and graphite as the anode, with excess cathode, compared with compared with the evolution of a cathode charge capacity of a cell fabricated with commercial LMO Y, where the cells were fabricated using the same processes. The superior performance of X compared to Y is expected from the results of FIG. 4.

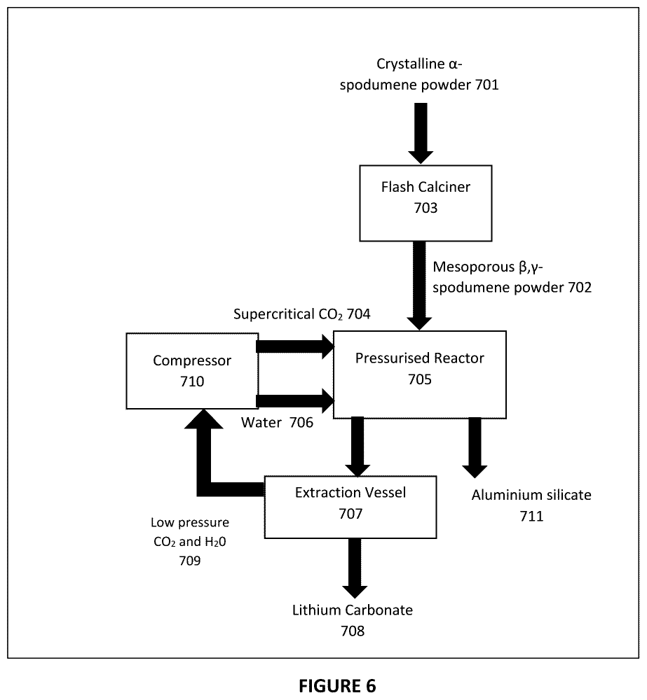

FIG. 6 shows an example embodiment of the process steps whereby Lithium is extracted from the mineral α-spodumene, LiAl(SiO₃)₂ to produce lithium carbonate. The first step is the calcination of α-spodumene 701 to produce β,γ-spodumene 702, preferably using the process is described by Sceats, Vincent et. al. in which flash calcination is used to minimise the residence time in the reactor 703, so that any silica does not have time to soften and coat the product, which would otherwise reduce the extraction of lithium from the silica and aluminium oxide. The usual extraction processes of lithium use dissolved acid or calcium oxide roasting processes to produce LiOH in a number of process steps using hydrometallurgical processes and pyroprocesses. LiOH, as LiOH·H₂O is difficult to transport because of hydration binds the powder, and many established lithium battery processes use Li₂CO₃ as the feedstock. This embodiment uses supercritical CO₂, and moisture, to extract the Li as Li₂CO₃ from β,γ-spodumene. It is noted that a pure CO₂ stream is produced in the calcination of MnCO₃ using the flash calcination method of Sceats et. al., and this stream may be used as a source of CO₂, and that the CO₂ is recycled. Thus a supercritical CO₂ stream, 704 is injected into a high pressure vessel 705 containing the β,γ-spodumene 702 and water 706 in a batch process and the temperature is raised to the point in which the lithium from the β,γ-spodumene is quickly released and dissolved in the fluid, and extracted from the particle, leaving an amorphous aluminosilicate material. The fluid is removed from the reactor and is decompressed in a vessel 707. The CO₂ gas and moisture are removed leaving behind a fine powder 708 of Li₂CO₃ as the product. This material is easy to transport as a fine powder, or may be processed by a recrystallisation process (not shown). The CO₂ and moisture 709 are recompressed in the compressor 710 and the outputs are supercritical CO₂ 704 and the water 706. The aluminosilicate is recovered as a product from the reactor vessel 711. The innovation used herein is to use the high reactivity of the β,γ-spodumene to speed up the extraction process which inhibits the application of the prior art.

In another embodiment, the use of high pressure CO₂, as the solvent for lithiation may be used, when saturated with the Li₂CO₃. This approach takes account of the lower free energy of the intercalated material and the process may be controlled by the pressure and temperature of the saturated CO₂ solvent. This is a specific embodiment of the lithiation process described in FIG. 2. This material may be lithiated with the process of FIG. 6 and preferably with the CO₂ and some moisture from the process in FIG. 6, may be used directly to lithiate mesoporous battery materials, such as Mn₃O₄ to produce LMO. The mining process of FIG. 8 may be decoupled physically from the manufacturing process described in this embodiment.

It is known that lithium batteries may run with excess cathode or anode materials to overcome the loss of lithium from SEI layers and the like. In another embodiment, the material Li₂MnO₃, known as a member of a class of Over-Lithiated Oxide (OLO) materials. Li₂MnO₃ may be formed as a mesoporous material using excess lithium in the intercalation of Mn₃O₄. The loss of lithium during charge and discharge cycles may be overcome by using either a mix of these materials or over lithiating the Mn₃O₄ material to form and mix of LMO and OLO, which has the advantage that the loss of lithium from OLO generates LMO which then contributes to performance. Most generally, the production of mesoporous materials and lithiation processes may be used to manufacture a wide range of OLO materials.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A process for processing an electroactive mesoporous material into a cathode, or an anode or a supercapacitor material using the steps of:
(a) modifying the material to remove impurities or substitute materials in the material by a hydrothermal process;
(b) intercalating the modified material by injecting the modified material with a charge carrier ion using a hydrothermal process or supercritical CO₂ fluid process where a solvent fluid contains a soluble compound of the charge carrier ion;
(c) sintering the intercalated material;
(d) providing a layer of a conducting material within a plurality of pores in the sintered material
(e) filling the pores and interparticle spaces with an electrolyte generally comprising the charge carrier ion and the solvent; and for solid state materials,
(f) polymerizing the solvent to encapsulate the mesoporous material;
where a common feature of the process steps involving fluid materials is that a capillary action of the pores in the mesoporous material pulls the fluid into the pores, and the fluid is chosen to substantially wet the pores of the material; and each process is carried out to ensure that the mesopore structure of the material in solid state is preserved; and
wherein lithiation by hydrothermal processing of the mesoporous powder in a 1-5M solution of LiOH followed by sintering produces a spinel lithium manganese oxide Li₁₊ₓ Mn₂₋ₓO₄(LMO); and wherein the lithium ratio is controlled to give the stoichiometric ratio of Li:Mn=1, to produce a tetragonal mesoporous material Li₂Mn₂O₃ (OLO) for use as a source of excess lithium in a cathode battery formulation.

2. The process of claim 1 in which the electroactive material is produced by either flash calcination of a precursor material that creates porosity by volatilization of constituents or by synthesis of a material, where a particle distribution is typically that of powders in a range of 1-100 microns and the pore properties are:
(a) a porosity in a range of 0.4-0.6; and
(b) a pore distribution with pores in a range of 3-130 nm; and
(c) a continuous pore structure which is hierarchical without a Lignification significant fraction of closed pores; and
(d) a Young's modulus of less than 10% of that of the solid material.

3. The process of claim 1 in which the modification step (a) wherein the impurity extraction rate, or substitution rate, maintains a grain size of the material less than about 40 nm; and which enables the production of stable mesoporous forms of the material.

4. The process of claim 1 in which the intercalation step (b) and the sintering step (c) is be operated over the course of multiple steps to achieve a stoichiometric transformation of a lithiated material, and the thermal stage, is optimised to achieve a stable material, while minimising mesopore ripening and/or facilitating desirable forms of the material for use as an anode, a cathode or a supercapacitor.

5. The process of claim 1 in which the electron conducting step (d) uses organic compounds such as sucrose, polystyrene, acetic acid, oxalic acid and citric acid dissolved in water, which after hydrothermal synthesis and/or pyrolysis, a conducting film of carbon is adhered to the pore surfaces.

6. The process of claim 1 in which the electron conducting step (d) uses grains of polyaniline in a solvent to form electron conducting pathways through the mesopores when the solvent is removed.

7. The process of claim 1 in which the electrolyte used in step (e) is Li⁺PF₆⁻ dissolved in a mixture of cyclic and linear organic carbonates such as ethylene carbonate, dimethyl carbonate, ethyl methyl carbonate and diethyl carbonate.

8. The process of claim 1 in which the polymerized electrolyte of step (f) has a high lithium conductivity, including materials such as polystyrene-polyethylene oxide block copolymers, nanoscale-phase separated materials, crosslinked materials with hairy nanoparticles, and lithium loaded nano-ceramic particles.

9. The process of claim 2, wherein the mesoporous material is a manganese oxide produced using a manganese salt with volatile constituents, in which the manganese salt is one or more selected from the group of: manganese carbonate, manganese acetate, and manganese citrate; in which, when flash calcined in a controlled atmosphere, liberates CO₂ and H₂O, to give a calcined material, where the calcination conditions are selected to produce the mesoporous material, wherein the mesoporous material has a surface area exceeding 20 m²/g and a composition which is a mixture of Mn₃O₄, MnO, Mn₂O₃ and uncalcined materials, with the Mn₃O₄ form dominating.

10. The process of claim 4, wherein the adsorption of lithium was controlled for the spinel lithium manganese oxide Li₁₊ₓMn₂₋ₓO₄(LMO) where x=0-0.1, and the processing condition include capillary action to draw the liquid into the mesoporous powder, heating the slurry and shearing the slurry to promote uniform lithiation, and the hydrothermal processing includes the use of additives such as surfactants, selected to produce an LMO powder with the highest specific surface area and the crystalline form of the powder product is the mesoporous polyhedral material for use as a cathode material for batteries.

11. The process of claim 10, wherein a portion of about 5% of the tetragonal mesoporous material Li₂Mn₂O₃ (OLO) is mixed with the LMO.

12. The process of claim 9, in which the hot calcined mesoporous material is postprocessed in a controlled atmosphere to achieve a material with a specific surface area of 60 m²/g which is a mixture of MnO₂, Mn₃O₄, Mn₂O₃ and uncalcined precursors forms, with the MnO₂ form dominating.

13. The process of claim 3, further comprising another processing step in which the fraction of MnO₂ is increased in the mesoporous product material.

14. The process of claim 5, wherein the processed mesoporous material produces a conducting carbon film on the surface of the pores, so that the material, when loaded with an electrolyte composed of specified ions, the material is used in the production of a supercapacitor.

15. A process of extracting lithium carbonate from a spodumene, the process comprising:
performing a flash calcination of a spodumene at a temperature of approximately 1000° C. to produce β,γ spodumene;
mixing the β,γ spodumene in a pressurized heated mixture that includes supercritical carbon dioxide and water; and
extracting lithium from the mixture, wherein the lithium is extracted within a time of two hours in the form of dissolved lithium carbonate.

16. The process of claim 15, further comprising:
separating a mixture comprising the carbon dioxide, water and lithium carbonate from solid residual aluminosilicate;
reducing a pressure of the pressurized mixture to atmospheric pressure; and
precipitating crystalline lithium carbonate from the mixture.

17. The process of claim 16, wherein the lithium carbonate which is used in the production of lithium ion batteries, and the carbon dioxide gas and steam stream is compressed to form supercritical carbon dioxide and water streams which are recycled for use in the step of flash calcination of αspodumene.

18. The process of claim 6, wherein the processed mesoporous material produces a conducting carbon film on the surface of the pores, so that the material, when loaded with an electrolyte composed of specified ions, the material is used in the production of a supercapacitor.

19. The process of claim 6, wherein the grains of polyaniline have a grain size in a range of 20 nm to 200 nm.
